(19) United States
(12) Patent Application Publication
(10) Pub. No.: US 2010/0081106 A1
(43) Pub. Date: Apr. 1, 2010

(54) ORTHODONTIC IMPLEMENT REMOVABLY ATTACHED TO LIP PROTECTOR

(76) Inventor: Hyo-Sang Park, Daegu (KR)

Correspondence Address: Customer No. 70416;Perkins Coie LLP, Patent - LA, P.O. Box 1208, Seattle, WA, 98111-1208, US

(21) Appl. No.: 12/358,267

(22) Filed: Jan. 23, 2009

(30) Foreign Application Priority Data
Sep. 26, 2008 (KR) 10-2008-0094665

(51) Int. Cl. A61C 7/12

(52) U.S. Cl. 433/8

(57) ABSTRACT

The present invention relates to an orthodontic implement removably attached to a lip protector adapted to cover an orthodontic appliance for correction of irregular alignment of teeth having orthodontic brackets attached on the faces of teeth and orthodontic wires and ligature wires adapted to apply an orthodontic force to the teeth by their elastic forces, so as to reduce the likelihood of the occurrence of the harmful stimulus applied to the interior of lips, wherein the orthodontic implement includes an orthodontic tube removably attached to the lip protector so as to transmit an orthodontic force applied from the pushing force applied from the lips to the teeth and having locking protrusions formed at the upper and lower end portions of an opening formed on the rear side thereof, such that the pushing force applied from the lips or tongue is transmitted to the teeth, thereby accelerating the orthodontic force.

### BACKGROUND OF THE INVENTION

1. Field of the Invention

The present invention relates to an orthodontic implement removably attached to a lip protector, and more particularly, to an orthodontic implement removably attached to a lip protector that improves an orthodontic force by using a force applied from the lips, while the lip protector is covering orthodontic brackets, orthodontic wires and ligature wires constituting an orthodontic appliance so as to reduce the likelihood of the occurrence of the harmful stimulus applied to the lips.

2. Background of the Related Art

Generally, an orthodontic treatment is required to correct the irregular alignment of teeth, thereby removing physiological or psychological troubles of an orthodontics patient. FIG. 1 is a perspective view showing a use state of a general orthodontic appliance 5, and as shown, the orthodontic treatment is carried out by attaching orthodontic brackets 2 to the faces of the teeth 1 and connecting orthodontic wires 3 through slots of the orthodontic brackets 2 by binding ligature wires 4, thereby applying an orthodontic force to the teeth of the patient.

The orthodontic treatment using the orthodontic appliance 5 as configured above needs a relatively long period of time, and since the orthodontic appliance 5 is placed between the teeth and lips, the interior of the mouse and lips may be damaged or even inflamed, and moreover, food may be fit to a gap formed between the slot of the orthodontic bracket 2 and the ligature wire 4, thereby making the patient feel uncomfortable.

So as to overcome the above-mentioned problems, there are proposed various lip protectors made of silicone for covering the orthodontic appliance 5.

The conventional lip protectors are disclosed in U.S. Pat. Nos. 4,913,654 and 5,037,296.

In the above-mentioned prior arts, the lip protector is formed of a band or tube type cover having locking protrusions or elastic clamps in such a manner as to be removably attached to the orthodontic brackets or wires constituting the orthodontic appliance.

The orthodontic appliance and the lip protector have their respective operating effects, but since it is difficult for the patient to maintain his or her interpersonal relationships and further the orthodontic treatment for a long period of time makes him or her feel uncomfortable in maintaining his or her daily life, he or she definitely wants to finish his or her orthodontic treatment as soon as possible. However, the duration of the orthodontic treatment cannot be reduced just using the conventional orthodontic appliance and lip protector.

### SUMMARY OF THE INVENTION

Accordingly, the present invention has been made in view of the above-mentioned problems occurring in the prior art, and it is an object of the present invention to provide an orthodontic implement removably attached to a lip protector that improves an orthodontic force by using a force applied from the lips, while the lip protector is covering orthodontic brackets, orthodontic wires and ligature wires constituting an orthodontic appliance so as to reduce the likelihood of the occurrence of the harmful stimulus applied to the lips, such that the duration of the orthodontic treatment is shortened and the psychological unease feeling of an orthodontics patient is removed.

To accomplish the above object, according to the present invention, there is provided an orthodontic implement removably attached to a lip protector adapted to cover an orthodontic appliance for correction of irregular alignment of teeth having orthodontic brackets attached on the faces of teeth and orthodontic wires and ligature wires adapted to apply an orthodontic force to the teeth by their elastic forces, so as to reduce the likelihood of the occurrence of the harmful stimulus applied to the interior of lips, wherein the orthodontic implement includes an orthodontic tube removably attached to the lip protector so as to transmit an orthodontic force obtained through the pushing force applied from the lips to the teeth and having locking protrusions formed at the upper and lower end portions of an opening formed on the rear side thereof, such that the pushing force applied from the lips or tongue is transmitted to the teeth, thereby accelerating the orthodontic force.

According to the present invention, the orthodontic implement is fit to the lip protector adapted to cover an orthodontic appliance so as to reduce the likelihood of the occurrence of the harmful stimulus applied to the interior of lips, thereby reducing the duration of the orthodontic treatment, and further, the orthodontic implement has elastic locking protrusions formed thereon so as to be easily and removably attached to the lip protector and has a relatively thick center portion so as to allow a pushing force applied from the lips to be stronger. In this case, only the lip protector is used during the daytime, which obtains good outer appearance thereof, and the orthodontic implement attached to the lip protector is used during the nighttime, thereby improving the orthodontic force.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing a use state of a general orthodontic appliance;

FIG. 2 is a sectional view showing a use state of a lip protector adopted in an orthodontic implement according to the present invention;

FIG. 3 is a plan view showing an orthodontic implement according to the present invention;

FIG. 4a is a sectional view taken along the line A-A′ of FIG. 3;

FIG. 4b is a sectional view taken along the line B-B′ of FIG. 3;

FIG. 5 is a sectional view showing the state where the orthodontic implement according to the present invention is attached to the lip protector;

FIG. 6 is an exemplary view showing the state where the orthodontic implement according to the present invention is attached to the lip protector; and

FIG. 7 is an exemplary view showing a use state of the orthodontic implement according to the present invention.

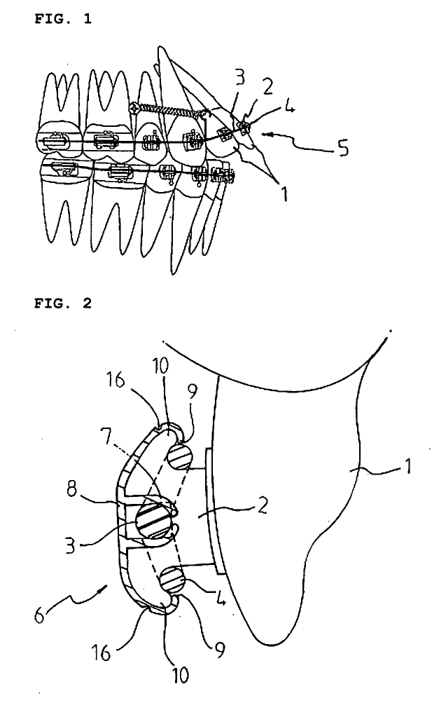

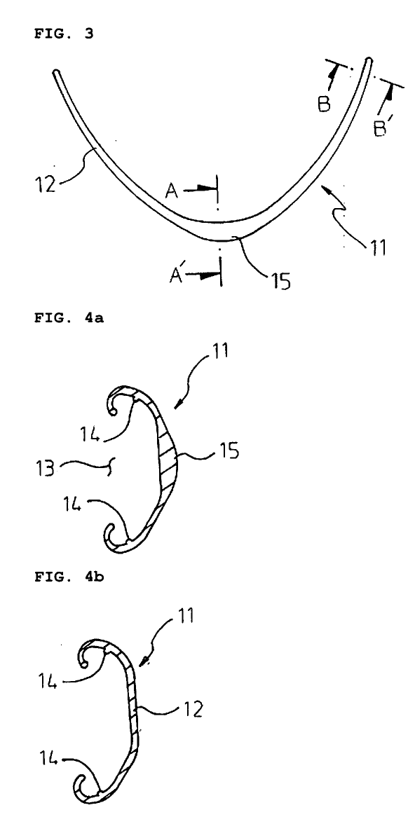

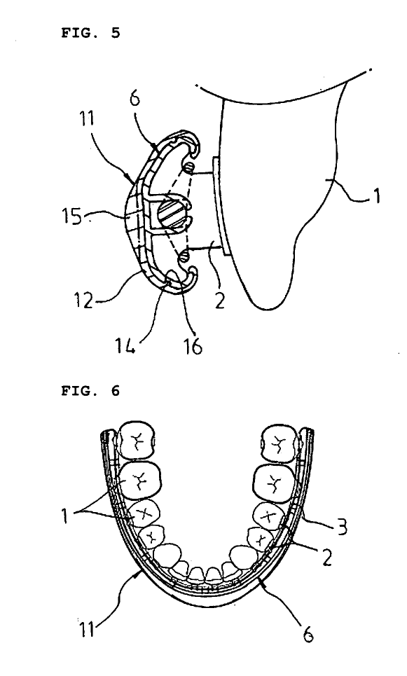

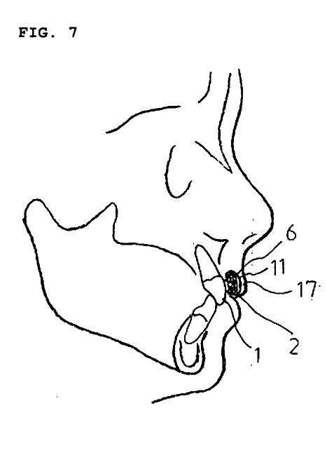

### DETAILED DESCRIPTION OF THE PREFERRED EMBODIMENT

Hereinafter, an explanation on the structure of an orthodontic implement removably attached to a lip protector according to the present invention will be in detail described with reference to the attached drawings.

As mentioned in the prior arts, an orthodontic appliance 5, which is for use in correction of the irregular alignment of teeth, includes: orthodontic brackets 2 attached on the faces of the teeth 1 by means of resin; orthodontic wires 3 connecting the orthodontic brackets 2 to one another so as to move the teeth 1 by means of elasticity; and ligature wires 4 adapted to be inserted into slots of the orthodontic brackets 2 so as to bind the orthodontic brackets 2 to the orthodontic wires 3.

As shown in FIG. 2, a lip protector 6, which is adapted to cover the orthodontic appliance 5 so as to reduce the likelihood of the occurrence of the harmful stimulus applied to the interior of the lips, includes: a cover 8 adapted to cover the orthodontic brackets 2, the orthodontic wires 3 and the ligature wires 4; a plurality of elastic clamps 7 formed at the inside of the center of the cover 8 so as to be fixedly inserted into the orthodontic wires 3; and locking ribs 9 adapted to be supported against upper and lower wings 10 of the orthodontic brackets 2.

An orthodontic implement 11 using the pushing force applied from the lips according to the present invention is made of colorless transparent silicone which gives no harm to the human body and provides good outer appearance thereof. Of course, the orthodontic implement 11 is soft and elastic so as to be removably attached to the lip protector 6.

The orthodontic implement 11 using the pushing force applied from the lips according to the present invention includes: an orthodontic tube 12 removably attached to the lip protector so as to transmit an orthodontic force obtained through the pushing force applied from the lips to the teeth 1; and locking protrusions 14 formed at the upper and lower end portions of an opening 13 formed on the rear side of the orthodontic tube 12 in such a manner as to be removably inserted into the lip protector 6.

The orthodontic tube 12 has a thick section portion 15 formed at the center thereof, which is more thicker than the both side end portions thereof, such that the pushing force applied from the lips are much more applied to the teeth 1.

The locking protrusions 14 formed at the upper and lower end portions of the opening 13 formed on the rear side of the orthodontic tube 12 are formed integrally with the orthodontic tube 12 in a horizontally elongated manner or in equally spaced manner apart from each other.

According to the lip protector 6 used together with the orthodontic implement 11 using the pushing force applied from the lips, the cover 8 has locking grooves 16 formed at the upper and lower end portions thereof so as to insert the locking protrusions 14 formed on the orthodontic tube 12 of the orthodontic implement 11, the locking grooves 16 being formed in a horizontally elongated manner or in equally spaced manner apart from each other.

Of course, the locking grooves 16 may be formed on the orthodontic tube 12 of the orthodontic implement 11 and the locking protrusions 14 may be formed on the cover 8 of the lip protector 6.

When the orthodontic treatment is conducted using the orthodontic implement 11 according to the present invention as constructed above, the elastic clamps 7 or the locking ribs 9 formed on the cover 8 of the lip protector 6 are fit to the orthodontic wires 3 or the orthodontic brackets 2 constituting the orthodontic appliance 5, thereby fixing the lip protector 6 to the orthodontic appliance 6. Next, the orthodontic implement 11 is pushed and insertedly fit to the lip protector 6 through the opening 13 in such a manner as to insert the locking protrusions 14 of the orthodontic tube 12 into the locking grooves 16 formed at the upper and lower end portions of the lip protector 6.

When the orthodontic implement 11 is fit to the lip protector 6 serving to reduce the likelihood of the occurrence of the harmful stimulus applied to the lips, the continuous or intermittent movements of the lips 17 or tongue push the thick section portion 15 formed at the center of the orthodontic tube 12 of the orthodontic implement 11, and the pushing force is transmitted to the teeth 1 to which the orthodontic appliance is attached, thereby accelerating the orthodontic force.

As described in the foregoing, according to the present invention, the orthodontic implement removably attached to a lip protector reduces the likelihood of the occurrence of the harmful stimulus applied to the lips through the lip protector and transmits the pushing force applied from the lips to the teeth, thereby accelerating the orthodontic force and shortening the duration of the orthodontic treatment, such that the psychological and economical load of the orthodontics patient can be reduced and the outer appearance after wearing can be more improved.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An orthodontic implement removably attached to a lip protector adapted to cover an orthodontic appliance for correction of the irregular alignment of teeth having orthodontic brackets attached on the faces of teeth and orthodontic wires and ligature wires adapted to apply an orthodontic force to the teeth by their elastic forces so as to reduce the likelihood of the occurrence of the harmful stimulus applied to the interior of lips, wherein the orthodontic implement includes an orthodontic tube removably attached to the lip protector so as to transmit an orthodontic force obtained through the pushing force applied from the lips to the teeth and having locking protrusions formed at the upper and lower end portions of an opening formed on the rear side thereof, such that the pushing force applied from the lips or tongue is transmitted to the teeth, thereby accelerating the orthodontic force.

2. The orthodontic implement according to claim 1, wherein the orthodontic tube has a thick section portion formed at the front center thereof.

3. The orthodontic implement according to claim 1, wherein the locking protrusions formed at the upper and lower end portions of the orthodontic tube are adapted to be inserted into locking grooves formed at the upper and lower end portions of the lip protector.

4. The orthodontic implement according to claim 1, wherein the lip protector and the orthodontic implement using the pushing force applied from the lips are made of colorless transparent silicone.
